(19) United States
(12) Patent Application Publication
(10) Pub. No.: US 2007/0025219 A1
(43) Pub. Date: Feb. 1, 2007

(54) Information playback apparatus and information playback method

(75) Inventors: Tatsuji Ashitani, Yokohama-Shi (JP); Yasuhiro Mll, Shinagawa-Ku (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-Ku (JP)

(21) Appl. No.: 11/460,432

(22) Filed: Jul. 27, 2006

(30) Foreign Application Priority Data
Jul. 28, 2005 (JP) 2005-219611

(51) Int. Cl. G11B 27/36

(52) U.S. Cl. 369/53.39

(57) ABSTRACT

An information playback apparatus according to the present invention plays back an information storage medium including first and second areas. The apparatus includes a moving unit to move an optical pickup in a diameter direction of the storage medium from the first area toward the second area; a feature signal generating unit to generate a feature signal on the basis of a signal output from the pickup, the feature signal indicating a feature of the first and second areas; a feature amount extracting unit to extract a feature amount from the feature signal, the feature amount indicating a feature of the first and second areas; and a movement determining unit to determine that the pickup has moved from the first area to the second area if a difference between the feature amount in the first area and the feature amount in the second area is larger than a predetermined threshold.

### BACKGROUND OF THE INVENTION

1. Field of the Invention

The present invention relates to an information playback apparatus and an information playback method and particularly to an information playback apparatus and an information playback method for playing back information recorded on an optical disc or the like.

2. Description of the Related Art

An information storage medium, such as an optical disc, conventionally has a special area called BCA (Burst Cutting Area), as well as a user area to store user data including video and audio data and various information data.

The BCA is provided on a recording surface of an optical disc and is made by barcode cutting or application of a coloring agent. The BCA is a ring-shaped area having a very small width of several millimeters and is provided at part of the inner periphery side of the optical disc.

Information important for appropriately playing back the optical disc, such as the type or identification information of the optical disc, is recorded in the BCA. Thus, the density of data recorded in the BCA is lower than that in a normal user area so that the data can be reliably read from the BCA.

In recent years, an area called a system lead-in area has emerged in a next-generation DVD, e.g., a HD DVD. The system lead-in area is defined to store the type and identification information of the medium, which has been diversified, and information to protect a copy right or the like.

The system lead-in area is a ring-shaped area of a very small width, as the above-described BCA. The recording form of information in the system lead-in area is different from that in the BCA. However, as in the BCA, the density of data recorded in the system lead-in area is lower than that in a normal user area so that the data can be reliably read therefrom.

Although a document disclosing a technique about a method for efficiently accessing a system lead-in area has not been found, JP 2004-127368 A discloses a technique about an access to a user area from a conventional lead-in area that is similar to the system lead-in area.

Typically, data recorded on an optical disc cannot be played back only by setting an absolute position of an optical pickup. A relative error between a laser spot and an information track needs to be controlled in order to absorb eccentricity of the optical disc or positional eccentricity due to axial displacement occurred when the disc is fixed.

In the user area, a signal to detect a relative position error, called a tracking error, between an information track and an optical pickup can be obtained, and address information indicating a physical position on the optical disc is included in information on the track. Thus, a relative error can be eliminated relatively accurately by using the signal and information. However, no information track exists near the BCA, and thus it is difficult to accurately search for the position of the BCA.

If the accuracy of an absolute position of a feed motor is sufficiently high and if the reproducibility is also high, it is theoretically possible to accurately set the optical pickup at a BCA position only by controlling the absolute position. However, if a highly-precise DC motor cannot be adopted or if a limit switch to initialize an absolute position cannot be provided due to cost constraint, the accuracy of the absolute position of the feed motor is insufficient for the positioning.

Therefore, a “trial-and-error” sequence of repeating trials while gradually displacing the absolute position of the optical pickup until BCA data can be read is required.

Also, the “trial-and-error” sequence is required in the system lead-in area as in the case of accessing the BCA, because the system lead-in area is relatively narrow as the BCA and a continuous recording area does not exist on both sides of the system lead-in area due to manufactural constraint of the disc.

In the “trial-and-error” sequence, an operation of moving a position of the optical pickup and performing playback is repeated, so that the time to access the BCA or the system lead-in area is long. When data recorded on the BCA or the system lead-in area cannot be read, a cause of the failure is difficult to determine, that is, whether the cause is too many errors, displacement, or absence of a BCA or a system lead-in area in the disc. As a result, the number of repetitions of trial unnecessarily increases, and the time to determine the type of disc becomes longer.

At worst, an actually-readable disc may be wrongly determined as impossible to be played back.

### SUMMARY OF THE INVENTION

The present invention has been made in view of the above-described circumstances and is directed to providing an information playback apparatus and an information playback method capable of accessing a specific area different from a user area, such as a BCA or a system lead-in area, efficiently and accurately in a short time.

According to an aspect of the present invention, there is provided an information playback apparatus to play back an information storage medium including a first area storing user data and a second area storing information with a density different from that in the first area. The information playback apparatus includes a moving unit to move an optical pickup in a diameter direction of the information storage medium from the first area toward the second area; a feature signal generating unit to generate a feature signal on the basis of a signal output from the optical pickup, the feature signal indicating a feature of the first and second areas; a feature amount extracting unit to extract a feature amount from the feature signal, the feature amount indicating a feature of the first and second areas; and a movement determining unit to determine that the optical pickup has moved from the first area to the second area if a difference between the feature amount obtained in the first area and the feature amount obtained in the second area is larger than a predetermined threshold.

According to another aspect of the present invention, there is provided an information playback method for playing back an information storage medium including a first area storing user data and a second area storing information with a density different from that in the first area. The information playback method includes a moving step of moving an optical pickup in a diameter direction of the information storage medium from the first area toward the second area; a feature signal generating step of generating a feature signal on the basis of a signal output from the optical pickup, the feature signal indicating a feature of the first and second areas; a feature amount extracting step of extracting a feature amount from the feature signal, the feature amount indicating a feature of the first and second areas; and a movement determining step of determining that the optical pickup has moved from the first area to the second area if a difference between the feature amount obtained in the first area and the feature amount obtained in the second area is larger than a predetermined threshold.

According to the information playback apparatus and the information playback method, a specific area different from a user area, such as a BCA or a system lead-in area, can be accessed efficiently and accurately in a short time.

### BRIEF DESCRIPTION OF THE DRAWINGS

FIG. 1 shows an example of a system configuration of an information playback apparatus according to a first embodiment of the present invention;

FIG. 2 shows an example of a data format of an optical disc that is played back by the information playback apparatus;

FIG. 3 shows a concept of waveforms of output signals from an optical pickup of the information playback apparatus;

FIG. 4 is a first illustration diagram of a feature signal and a feature amount according to the first embodiment;

FIG. 5 is a second illustration diagram of the feature signal and the feature amount according to the first embodiment;

FIG. 6 is a flowchart showing an example of an operation sequence performed by the information playback apparatus;

FIG. 7 is an illustration diagram of a feature signal and a feature amount according to a second embodiment;

FIG. 8 is an illustration diagram of a feature signal and a feature amount according to a third embodiment;

FIG. 9 is an illustration diagram of a feature signal and a feature amount according to a fourth embodiment; and

FIG. 10 is an illustration diagram of a feature signal and a feature amount according to a fifth embodiment.

### DESCRIPTION OF THE PREFERRED EMBODIMENTS

Hereinafter, an information playback apparatus and an information playback method according to embodiments of the present invention are described with reference to the attached drawings.

### (1) First Embodiment

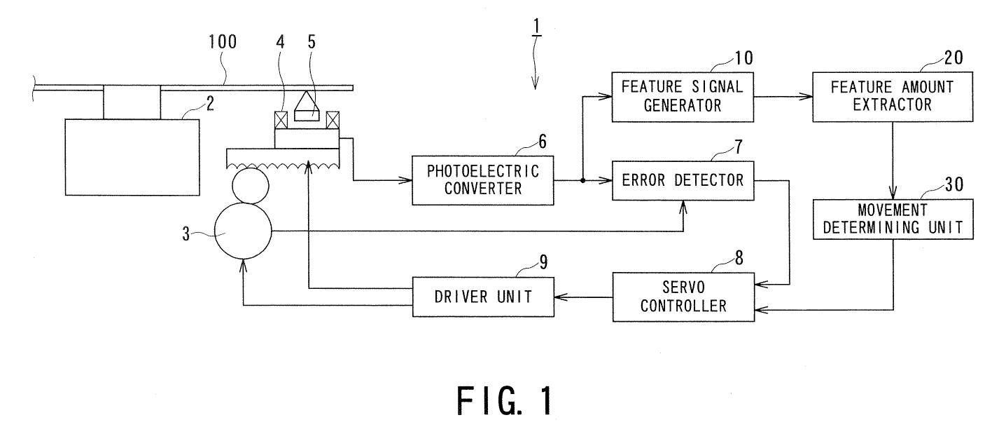

FIG. 1 shows an example of a system configuration of an information playback apparatus 1 according to a first embodiment.

The information playback apparatus 1 includes a spindle motor 2 to drive and rotate an optical disc 100; a feed motor 3 (moving unit) to drive an objective lens 5 and a lens actuator 4 in a diameter direction of the optical disc 100; a photoelectric converter 6 to convert reflected light from the optical disc 100 to an electric signal; an error detector 7 to generate a focus error signal and a tracking error signal on the basis of a signal output from the photoelectric converter 6; a servo controller 8 to perform servo control on the basis of the focus error signal and the tracking error signal; and a driver unit 9 to generate a driving signal for the feed motor 3 and the lens actuator 4 on the basis of a control signal output from the servo controller 8.

The information playback apparatus 1 also includes a feature signal generator (a feature signal generating unit) 10 to generate a feature signal on the basis of an RF signal output from the photoelectric converter 6 or a tracking error signal output from the error detector 7; a feature amount extractor (a feature amount extracting unit) 20 to extract a feature amount from the feature signal; and a movement determining unit 30 to determine whether the feed motor 3 is moving or stopped on the basis of the feature amount.

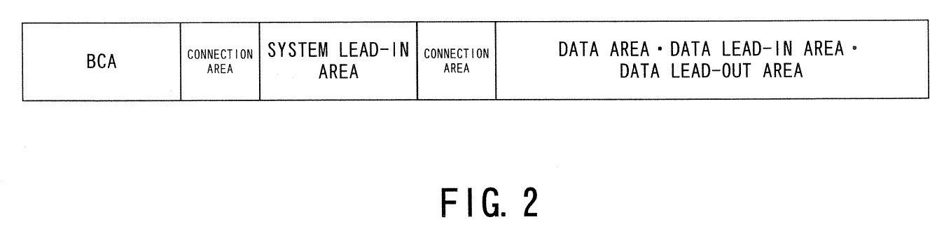

FIG. 2 schematically illustrates a recording format of a HD DVD, which is an example of the optical disc 100 played back by the information playback apparatus 1. The left side of FIG. 2 corresponds to an inner periphery side of the optical disc 100 and the right side thereof corresponds to an outer periphery side of the optical disc 100.

A major area of the optical disc 100 is a data area (first area) where video and audio signals and various information data are recorded in a broad sense. The data area includes a data lead-in area and a data lead-out area depending on its application, but the physical structure thereof is the same.

On the inner periphery side of the optical disc 100, a system lead-in area is provided next to a connection area, and also a BCA is provided next to another connection area. The system lead-in area and the BCA (second area) are ring-shaped areas of a very small width and have a physical structure different from that of the data area.

The BCA is provided on a recording surface of the optical disc 100 and is made by barcode cutting or application of a coloring agent. Information that is required immediately after a disc drive has started, e.g., the type of the disc, is recorded in the BCA.

In the system lead-in area, a track pitch and a pit size are larger than those in the data area. Information indicating details of a disc type and information about a copy right are recorded therein. Incidentally, the recording density in the BCA is lower than that in the system lead-in area.

Hereinafter, a signal output from the photoelectric converter 6 or the error detector 7 of the information playback apparatus 1 is described.

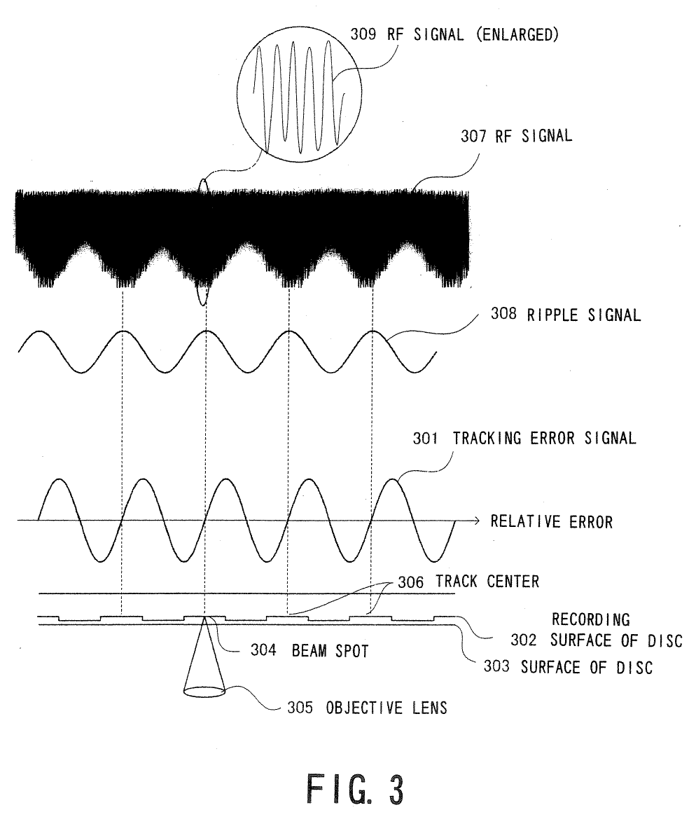

FIG. 3 shows waveforms of various output signals. The horizontal axis indicates the amount of displacement of a beam spot 304 moving in a diameter direction of the optical disc 100.

An RF signal 307 shown at the top is also called a sum signal and is used to play back information recorded on the optical disc 100. Fluctuations of this signal can be seen in an enlarged view denoted by reference numeral 309, and this signal corresponds to a digital signal “0” and “1” recorded as a pit on a track. The amplitude of an envelope of the RF signal 307 is the largest at the center of a track and is the smallest at the center between tracks. The RF signal 307 is output from the photoelectric converter 6 and is then input to a data playback system (not shown) in the subsequent stage. Also, the RF signal 307 is input to the feature signal generator 10 of the information playback apparatus 1.

The second waveform from the top is of a ripple signal 308, which is generated by detecting the amplitude or peak of the RF signal 307. As the envelope of the RF signal 307, the amplitude thereof is the largest at the center of a track and is the smallest at the center between tracks.

As described below, the ripple signal 308 has different waveforms in the data area and the system lead-in area (hereinafter, the BCA and the system lead-in area are collectively referred to as a system lead-in area). A feature amount of each area can be extracted, so that the ripple signal 308 may be called a feature signal. The ripple signal 308 is generated by the feature signal generator 10 on the basis of the RF signal 307 (generated by amplitude detection in this case).

The third waveform from the top is of a tracking error signal 301, which may be generated in the error detector 7 of the information playback apparatus 1 on the basis of an output signal from the photoelectric converter 6 and can be obtained through an operation, such as a phase detecting method or a push-pull method. The tracking error signal 301 shows a substantially trigonometric-function-like waveform in accordance with the amount of displacement of the beam spot 304. In the vicinity of a track center 306, a linear error signal proportional to the amount of displacement can be obtained. However, the slope of the waveform is inverted after a half track, and a linear error signal is obtained again in an adjacent track.

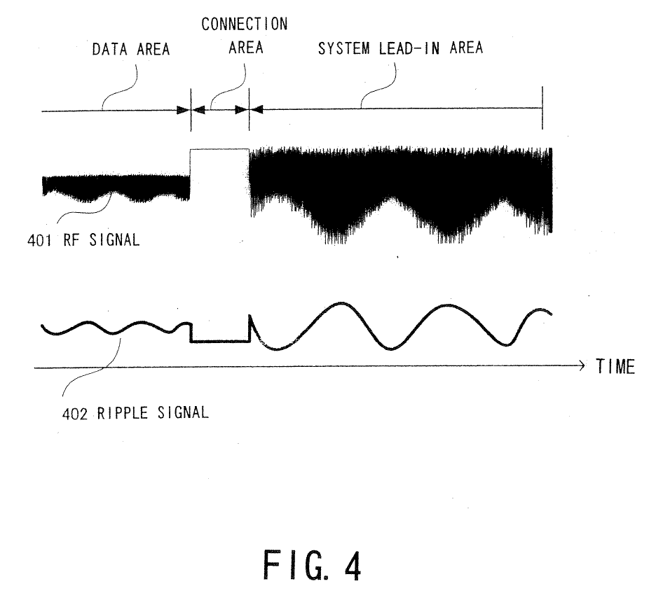

FIG. 4 shows waveforms of an RF signal 401 and a ripple signal 402 obtained when the optical pickup is moved by the feed motor 3 from the data area toward the system lead-in area.

Since the track pitch and the pit width in the system lead-in area are larger than those in the data area, the amplitude of the RF signal 401 and the ripple signal 402 is larger in the system lead-in area than in the data area. The connection area, which is an unrecorded area, is a mirror-surface area and has a high reflectivity. Thus, the level of the RF signal 401 is high in the connection area. The system lead-in area can be searched for by using this characteristic.

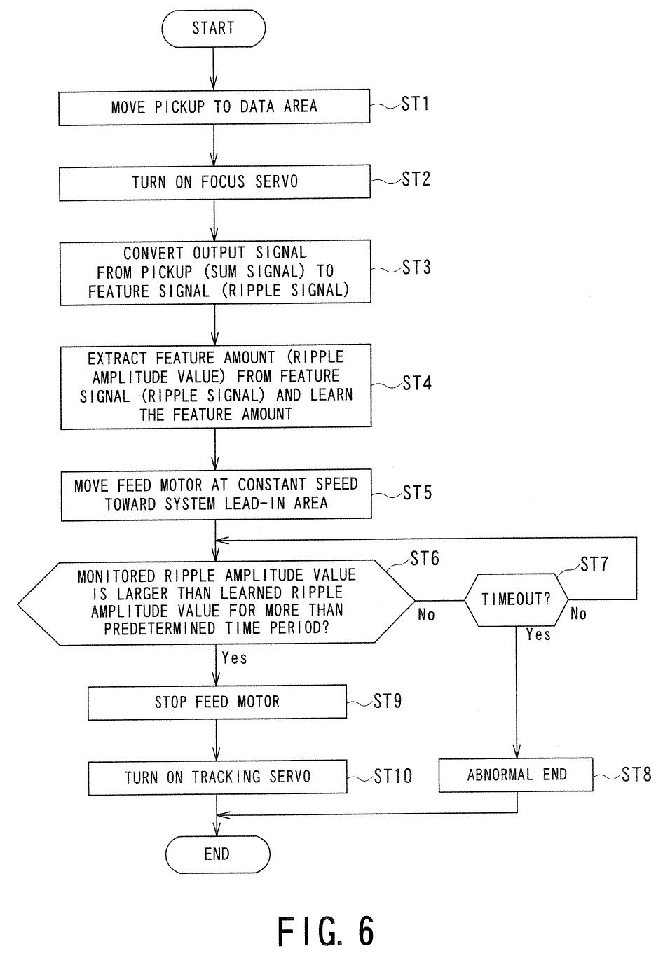

FIG. 6 is a flowchart showing an example of an operation to search for the system lead-in area, the operation being performed by the information playback apparatus 1 according to the first embodiment.

First, the optical pickup is moved to the data area (step ST1). The data area occupies the most part of the optical disc 100, and thus positioning can be done only with the absolute position accuracy of the feed motor 3.

Then, the focus servo is turned on (step ST2). With this operation, a laser beam is focused on a recording surface of the optical disc 100, so that the optical pickup outputs an RF signal (sum signal). The RF signal is converted to a ripple signal (feature signal) in the feature signal generator 10 (step ST3).

Under this state, a ripple amplitude value is extracted as a feature amount from the ripple signal, and the extracted ripple amplitude value is learned (step ST4). The ripple amplitude value as a feature amount is extracted in the feature amount extractor 20 of the information playback apparatus 1.

Then, changes in the ripple amplitude value is monitored while the feed motor 3 being fed at a substantially constant speed in the direction of the system lead-in area (step ST5).

If the monitored ripple amplitude value is larger than the learned ripple amplitude value in the data area for more than a predetermined time period (Yes in step ST6), it is determined that the optical pickup has entered the system lead-in area. The determination is made by the movement determining unit 30.

Then, the feed motor 3 is stopped (step ST9), and the tracking servo is turned on (step ST10). The turning on of the tracking servo enables read of data from the system lead-in area.

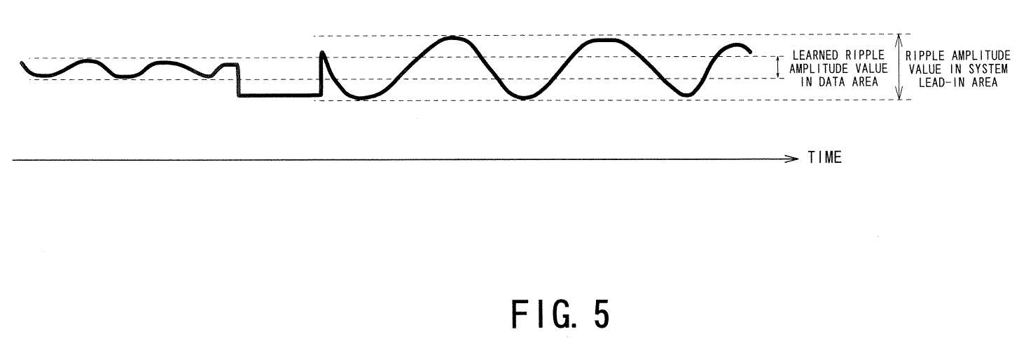

FIG. 5 shows a relationship between the learned ripple amplitude value in the data area and the ripple amplitude value obtained in the system lead-in area. It is determined that the optical pickup has entered the system lead-in area if a relative value (e.g., the ratio) between the ripple amplitude value obtained in the system lead-in area and the learned ripple amplitude value in the data area is higher than a predetermined threshold for more than a predetermined time period.

The determination may be made on the basis of only the absolute value of the ripple amplitude value in the system lead-in area, but the absolute ripple amplitude value typically varies depending on the type of optical disc or individual difference. Thus, the reliability of determination is higher when the determination is made on the basis of a relative value between the learned ripple amplitude value in the data area and the ripple amplitude value in the system lead-in area. The reliability can further be enhanced by determining whether the relative value is continuously over the threshold for a predetermined time period, compared to a case where the determination is made instantaneously.

In the information playback apparatus 1 according to this embodiment, access from the data area to the system lead-in area can be done efficiently and accurately in a short time.

Incidentally, it may be determined that the optical pickup has entered the system lead-in area if the position of the optical pickup is away from the start point of the connection area by a predetermined distance. However, in a next-generation DVD, e.g., in a HD DVD, a physical length of a connection area is not precisely defined due to restrictions in a disc manufacturing process, although a certain upper limit thereof is set. Therefore, determination based on a distance from the start point of the connection area is unreliable. According to this embodiment, this problem does not occur in the next-generation DVD, e.g., a HD DVD.

In the first embodiment, a ripple signal is used as a feature signal and an amplitude value of the ripple signal is used as a feature amount. Hereinafter, other embodiments in which another signal is used as a feature signal or a feature amount are described.

### (2) Other Embodiments

In the following embodiments, the system configuration and the operation flow are the same as those in the first embodiment, but a feature signal and a feature amount are different. Thus, the feature signal and the feature amount are mainly described below.

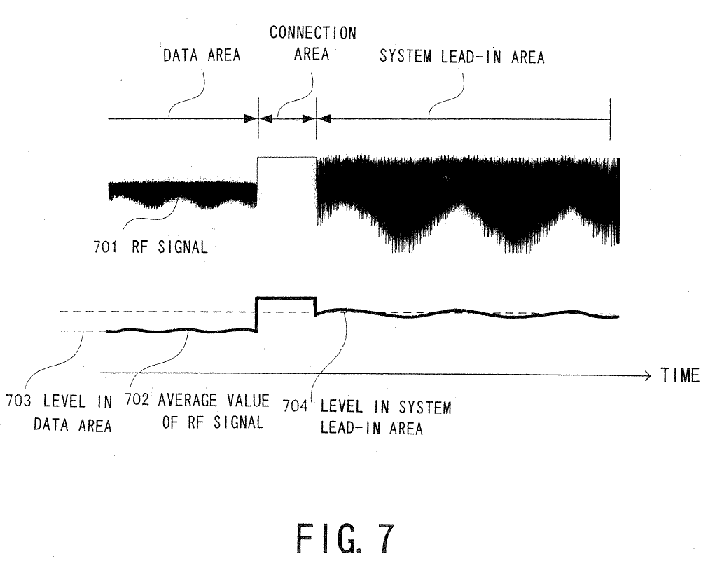

FIG. 7 shows a feature signal and a feature amount according to a second embodiment. In the second embodiment, an average value of an RF signal (smoothed signal) is used as a feature signal. A level value of the average value of the RF signal (average value of the smoothed signal) is used as a feature amount. As can be seen in FIG. 7, the level value is small in the data area and is large in the system lead-in area. By comparing the ratio between the level values in the both areas with a predetermined threshold by using this characteristic, whether the optical pickup has entered the system lead-in area can be determined.

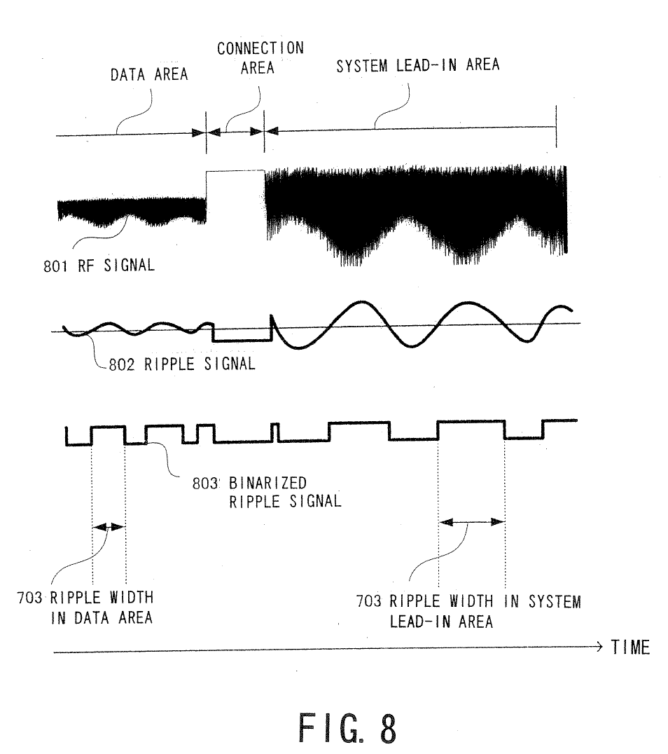

FIG. 8 shows a feature signal and a feature amount according to a third embodiment. In the third embodiment, a binarized ripple signal is used as a feature signal. A ripple width extracted from the binarized ripple signal is used as a feature amount.

As described above, the pitch of tracks in the system lead-in area is larger than that in the data area. Therefore, as shown in FIG. 8, the ripple width of the ripple signal is small in the data area but is large in the system lead-in area. By comparing the ratio between the ripple widths in the both areas with a predetermined threshold by using this characteristic, whether the optical pickup has entered the system lead-in area can be determined.

The binarized ripple signal is used as a feature signal so that a ripple width can be easily extracted.

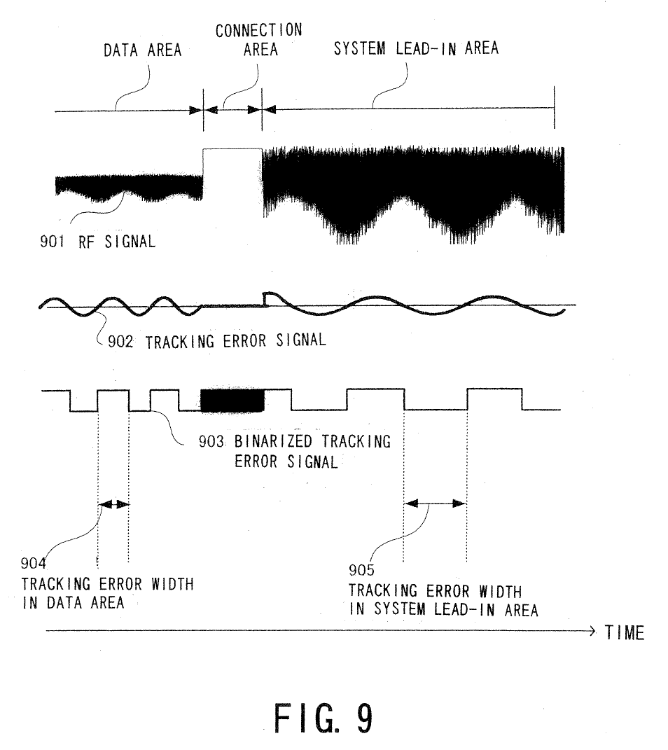

FIG. 9 shows a feature signal and a feature amount according to a fourth embodiment. In the fourth embodiment, a binarized tracking error signal is used as a feature signal. A tracking error width extracted from the binarized tracking error signal is used as a feature amount.

The tracking error signal varies in accordance with a track pitch. Therefore, as shown in FIG. 9, the error width of the tracking error signal is small in the data area but is large in the system lead-in area. By comparing the ratio between the error widths in the both areas with a predetermined threshold by using this characteristic, whether the optical pickup has entered the system lead-in area can be determined.

The binarized tracking error signal is used as a feature signal so that an error width can be easily extracted, as in the third embodiment.

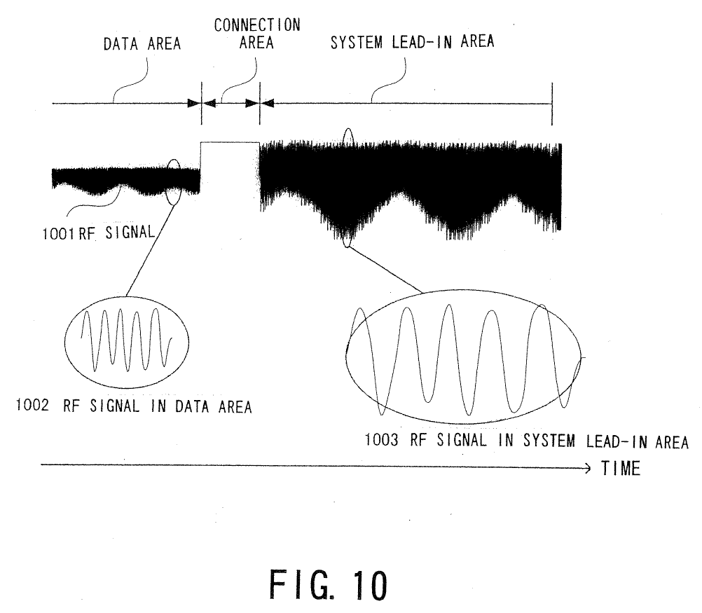

FIG. 10 shows a feature signal and a feature amount according to a fifth embodiment. In the fifth embodiment, an RF signal is used as a feature signal. A frequency of the RF signal (not frequency of an envelope) is used as a feature amount.

The pit size in the data area is different from that in the system lead-in area. The pit size in the system lead-in area is larger than that in the data area. Therefore, if the optical pickup moves from the data area to the system lead-in area while the optical disc rotates at a constant angular velocity, the frequency of the RF signal changes. As shown in FIG. 10, the frequency in the system lead-in area is lower than that in the data area. By comparing the ratio between the frequencies of the RF signal in the both areas with a predetermined threshold by using this characteristic, whether the optical pickup has entered the system lead-in area can be determined.

The frequency of the RF signal is extracted by the feature amount extractor 20 in the system configuration shown in FIG. 1. However, when data is to be played back in synchronization, the frequency of the RF signal needs to be measured. Thus, a detecting circuit to detect a specific pattern and measure the intervals thereof or measure an average interval is provided in many cases. In that case, the frequency of the RF signal that has been detected for synchronization playback may be used.

The present invention is not limited to the above-described embodiments, but can be embodied by modifying the elements without deviating from the scope of the present invention. Also, various modifications can be realized by various combinations of a plurality of elements disclosed in the above-described embodiments. For example, some elements among all of the elements described in the embodiments may be deleted. Further, a combination of elements may be made over different embodiments.

What is claimed is:

1. An information playback apparatus to play back an information storage medium including a first area storing user data and a second area storing information with a density different from that in the first area, the information playback apparatus comprising:
a moving unit to move an optical pickup in a diameter direction of the information storage medium from the first area toward the second area;
a feature signal generating unit to generate a feature signal on the basis of a signal output from the optical pickup, the feature signal indicating a feature of the first and second areas;
a feature amount extracting unit to extract a feature amount from the feature signal, the feature amount indicating a feature of the first and second areas; and
a movement determining unit to determine that the optical pickup has moved from the first area to the second area if a difference between the feature amount obtained in the first area and the feature amount obtained in the second area is larger than a predetermined threshold.

2. The information playback apparatus according to claim 1,
wherein the feature signal generating unit extracts a ripple signal as the feature signal from a sum signal output from the optical pickup, the ripple signal being generated by detecting an amplitude of the sum signal, and
wherein the feature amount extracting unit extracts a ripple amplitude value of the ripple signal as the feature amount.

3. The information playback apparatus according to claim 1,
wherein the feature signal generating unit extracts a ripple signal as the feature signal from a sum signal output from the optical pickup, the ripple signal being generated by detecting an amplitude of the sum signal, and
wherein the feature amount extracting unit extracts a ripple width of the ripple signal as the feature amount.

4. The information playback apparatus according to claim 1,
wherein the feature signal generating unit extracts a smoothed signal as the feature signal from a sum signal output from the optical pickup, the smoothed signal being generated by smoothing the sum signal, and
wherein the feature amount extracting unit extracts an average value of the smoothed signal as the feature amount.

5. The information playback apparatus according to claim 1,
wherein the feature signal generating unit extracts a binarized tracking signal as the feature signal from a tracking signal output from the optical pickup, the binarized tracking signal being generated by binarizing the tracking signal, and
wherein the feature amount extracting unit extracts an error width of the binarized tracking signal as the feature amount.

6. The information playback apparatus according to claim 1,
wherein the feature signal generating unit extracts a sum signal output from the optical pickup as the feature signal, and
wherein the feature amount extracting unit extracts a frequency of the sum signal as the feature amount.

7. The information playback apparatus according to claim 1, wherein the optical pickup is moved under a state where a focus servo is turned on.

8. The information playback apparatus according to claim 1, wherein the movement determining unit determines that the optical pickup has moved from the first area to the second area if the difference is larger than the predetermined threshold for more than a predetermined time period.

9. An information playback method for playing back an information storage medium including a first area storing user data and a second area storing information with a density different from that in the first area, the information playback method comprising the steps of:
moving an optical pickup in a diameter direction of the information storage medium from the first area toward the second area;
generating a feature signal on the basis of a signal output from the optical pickup, the feature signal indicating a feature of the first and second areas;
extracting a feature amount from the feature signal, the feature amount indicating a feature of the first and second areas; and
determining that the optical pickup has moved from the first area to the second area if a difference between the feature amount obtained in the first area and the feature amount obtained in the second area is larger than a predetermined threshold.

10. The information playback method according to claim 9,
wherein the step of generating extracts a ripple signal as the feature signal from a sum signal output from the optical pickup, the ripple signal being generated by detecting an amplitude of the sum signal, and
wherein the step of extracting extracts a ripple amplitude value of the ripple signal as the feature amount.

11. The information playback method according to claim 9,
wherein the step of generating extracts a ripple signal as the feature signal from a sum signal output from the optical pickup, the ripple signal being generated by detecting an amplitude of the sum signal, and
wherein the step of extracting extracts a ripple width of the ripple signal as the feature amount.

12. The information playback method according to claim 9,
wherein the step of generating extracts a smoothed signal as the feature signal from a sum signal output from the optical pickup, the smoothed signal being generated by smoothing the sum signal, and
wherein the step of extracting extracts an average value of the smoothed signal as the feature amount.

13. The information playback method according to claim 9,
wherein the step of generating extracts a binarized tracking signal as the feature signal from a tracking signal output from the optical pickup, the binarized tracking signal being generated by binarizing the tracking signal, and
wherein the step of extracting extracts an error width of the binarized tracking signal as the feature amount.

14. The information playback method according to claim 9,
wherein the step of generating extracts a sum signal output from the optical pickup as the feature signal, and
wherein the step of extracting extracts a frequency of the sum signal as the feature amount.

15. The information playback method according to claim 9, wherein the optical pickup is moved under a state where a focus servo is turned on.

16. The information playback method according to claim 9, wherein the step of determining determines that the optical pickup has moved from the first area to the second area if the difference is larger than the predetermined threshold for more than a predetermined time period.
